(19) United States
(12) Patent Application Publication
(10) Pub. No.: US 2007/0208609 A1
(43) Pub. Date: Sep. 6, 2007

(54) SUPPLY AND DEMAND PLANNING INCLUDING BACKWARDS ORDER ITEM ALLOCATION

(75) Inventors: Orna R. Anker, Stamford, CT (US); Orla C. Doyle, Glasnevin, Dublin 9 (IE); Anthony V. Ferreri, Hyde Park, NY (US); Lawrence R. Fox, Poughkeepsie, NY (US); Glenn E. Pedersen, Montgomery, NY (US)

Correspondence Address: HOFFMAN, WARNICK & D'ALESSANDRO LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/308,027

(22) Filed: Mar. 3, 2006

(51) Int. Cl. G07G 1/00

(52) U.S. Cl. 705/10

(57) ABSTRACT

A method, system and program product for providing supply and demand planning including backwards order item allocation is disclosed. In one embodiment, the invention includes a method for supply and demand planning in an enterprise including: identifying an order item occurring at a prospective period that exceeds an enterprise build plan for the prospective period; and allocating at least a portion of the order item back to a supplier forecast for at least one period prior to the prospective period.

### BACKGROUND OF THE INVENTION

1. Technical Field

The invention relates generally to supply and demand planning, and more particularly, to supply and demand planning including backwards order item allocation.

2. Background Art

Competitive commercial enterprises require accurate supply and demand planning to determine the need for particular units for completing sellable items, e.g., products and/or services. One challenge in this area is providing an enterprise's suppliers with a consistent supplier forecast with the most up-to-date view of the enterprise's demand for their long range resource planning. Conventional forecasting techniques allow order backlog, i.e., order items ready to be processed at the manufacturer, to be passed to suppliers as firm demand, i.e., needed now. At the same time, the enterprise's build plan, i.e., forecasted objective, for the corresponding period of time is reduced. The consumption proceeds week by week within the current month and then challenges the suppliers by consuming future forecasted build plan. This occurs even for order items that exceed a build plan, and thus require a larger than normal number of units for completion during a specific period. Based on typical ordering trends, these larger order items occur at month's end or a quarter's end. As a result, this can create an over planning situation by not utilizing the earlier forecasted opportunity to satisfy the order demands above the build plan and thus establishing a bubble of inventory liability.

To illustrate, FIG. 1 shows a supply and demand planning spreadsheet 2 including an illustrative situation. (The forecasting technique mandates review in terms of five day weeks, hence, the months are slightly askew with July including 5 weeks and August and September including 4 weeks). An enterprise build plan 10 represents the number of sellable items that the enterprise wants to build within a specific period, e.g., a week, a month, a quarter, etc. For the third quarter (3Q) illustrated, the enterprise has an objective of generating 200 units as its build plan. (The spreadsheet assumes a one-for-one unit attach rate per sellable item, i.e., one sellable item requires one unit from the supplier). The build plan is used to provide suppliers with a supplier forecast 20, and ensure that units are on-hand to fulfill order items for the quarter. For example, the illustrative build plan 10 calls for building 20 sellable items per week in July and 25 sellable items per week in August to achieve the 200 sellable item objective. The order backlog 12 (Order BL) indicates actual order items received by the enterprise, e.g., firm order items from customers to be fulfilled by the enterprise. For example, the spreadsheet shows 20 units for week 6/14, 15 for week 6/21, 25 for week 6/28, 30 for week 8/23, 155 for week 9/20, and zero for the other weeks of the quarter. The order item 22 (including 155 sellable items) represents an atypically large order item because the build plan 10 quantity was not large enough to contain the order item 22, therefore the number of sellable items would exceed the build plan by 155 for the quarter.

Conventionally, a supplier forecast 20 indicated to a supplier is based on an aggregated demand 14 (Demand), which includes orders from demand order 18 (“B. Order” in FIG. 1) (also indicated as order backlog 12 (firm orders)) and forecasted demand 16. The forecasted demand 16 indicates the number of units in build plan 10 for a specific period not consumed by the order backlog 12, e.g., build plan minus order backlog. For example, 15 sellable items were ordered for week 6/21 which is consumed from the build plan 10 with a quantity of 20 in the same week. This results in an aggregated demand 14 for that week of 20 units based on: an order backlog of 15 units ordered (i.e., 15 o) with a demand forecast of 5 more (i.e., 5 f) and, hence, a supplier forecast 20 of 20 units in the same week. Another notable situation: since an order item of 25 units was received for week 6/28, which is 5 more than anticipated, the demand forecast 16 for the next week is reduced by 5 units. Similarly, since an order item of 30 units was received for delivery 8/23, which is 5 more than anticipated, the supplier forecast 20 for the previous week 8/16 is reduced by 5 units (i.e., to 20). In any event, the aggregated demand 14 or supplier forecast 20 is the number of units the enterprise forecasts as required for the particular week in question, i.e., ordered and forecasted.

One problem with the above-described situation is that, ideally, the supplier forecast 20 should be as consistent as possible. However, as shown in FIG. 1, the supplier forecast 20, while mostly consistent, includes a large spike for the 9/20 order item 22. More specifically, conventional forecasting techniques allow the order backlog 1 2 at the enterprise to enter the supplier forecast 20 as though they are firm order demand only. This situation results in a spike in the supplier forecast 20 at the end of a month or quarter, which is inconsistent with previous supplier forecasts. That is, the larger than normal order item 22 results in an aggregate supplier forecast for the quarter of 355 units for the quarter, which exceeds the quarterly objective of 200 units by 155 units. This results in over planning, establishing a bubble of inventory liability by not utilizing the earlier forecast opportunity (i.e., 7/5 to 8/16) for the demand later in the quarter. This situation is frustrating for the supplier because the order item 22 represents a challenge to fulfill because it is unexpected, and once fulfilled may result in no further demand. In addition, this situation is frustrating for the enterprise because, if the supplier delivers, it may be impossible to use the units delivered during the quarter in question, especially if the units must go through a pre-manufacture testing. That is, it is ideal that the supplier forecast 20 match the build plan 10. The above-described situation also presents the enterprise with increased inventory issues, e.g., increase liability for in-house inventory for extended periods of time.

In view of the foregoing, there is a need in the art for a solution that allows for improved accuracy in supply and demand planning.

### SUMMARY OF THE INVENTION

A method, system and program product for providing supply and demand planning including backwards order item allocation is disclosed. In one embodiment, the invention includes a method for supply and demand planning in an enterprise including: identifying an order item occurring at a prospective period that exceeds an enterprise build plan for the prospective period; and allocating at least a portion of the order item back to a supplier forecast for at least one period prior to the prospective period.

A first aspect of the invention provides a method for supply and demand planning in an enterprise, the method comprising the steps of: identifying an order item occurring at a prospective period that exceeds an enterprise build plan for the prospective period; and allocating at least a portion of the order item to a supplier forecast for at least one period prior to the prospective period.

A second aspect of the invention provides a system for supply and demand planning, the system comprising: an analyzer unit for identifying an order item occurring at a prospective period that exceeds an enterprise build plan for the prospective period; and an allocator unit for allocating at least a portion of the order item to a supplier forecast for at least one period prior to the prospective period.

A third aspect of the invention provides a program product stored on a computer-readable medium, which when executed, provides supply and demand planning for a unit, the program product comprising: program code for identifying an order item occurring at a prospective period that exceeds an enterprise build plan for the prospective period; and program code for allocating at least a portion of the order item to a supplier forecast for at least one period prior to the prospective period.

A fourth aspect of the invention provides a computer-readable medium that includes computer program code to enable a computer infrastructure to provide supply and demand planning, the computer-readable medium comprising computer program code for performing the method steps of the invention.

A fifth aspect of the invention provides a business method for providing supply and demand planning, the business method comprising managing a computer infrastructure that performs each of the steps of the invention; and receiving payment based on the managing step.

A sixth aspect of the invention provides a method of providing a service including supply and demand planning, the method comprising: obtaining a computer infrastructure; and for each of the method steps of the invention, deploying a unit for performing the step to the computer infrastructure.

The illustrative aspects of the present invention are designed to solve the problems herein described and other problems not described that are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a table illustrating one method of supply and demand planning according to the prior art.

FIG. 2 shows a block diagram of a planning system according to one embodiment of the invention.

FIG. 3 shows a table illustrating one embodiment of a method of supply and demand planning according to the invention.

FIG. 4 shows a flow diagram of one embodiment of an operational methodology of the system of FIG. 2.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As used herein, the following terms shall have the following meanings:

“Order item” is any identification of an order or request for provision of a sellable item. An order item may include an identification by an actual order (i.e., a request for provision of a sellable item), or an identification by a particular customer, or an identification by a planning item (i.e., a sellable item providers internal grouping).

“Sellable item” means any product and/or service that can be sold, e.g., a computer, an automobile, consulting service, etc.

“Enterprise” is a provider of sellable items.

“Unit” means any lower level component of a sellable item, e.g., for a computer, a hard disk drive, a power unit, a video card, a certain memory, etc.

“Unit attach rate” means number of units used per a number of sellable items. For example, 500 cars out of 3500 vehicles sold by an automobile manufacturer may include an AM-FM stereo without a CD player, resulting in an attach rate of 14.3%. Similarly, 2000 cars out of 3500 vehicles may include an AM-FM stereo with a CD player, resulting an attach rate of 57.1%.

“Shipment history” is information regarding order items that include a unit and have already been fulfilled.

“Build plan” represents the number of sellable items that the enterprise wants to build within a specific period, e.g., a week, a month, a quarter, etc.

“Order backlog” are current unfulfilled order items that are creating a demand, or backlog, for a unit at the enterprise.

“Aggregated demand” is a demand including order backlog plus demand forecast. Order backlog is referred to as “demand order” relative to the aggregate demand.

“Demand forecast” is a predicted number of units required for future order items and is calculated based on a build plan minus order backlog.

“Supplier forecast” is a number of units predicted to be required from a supplier based on a build plan, order backlog and demand forecast.

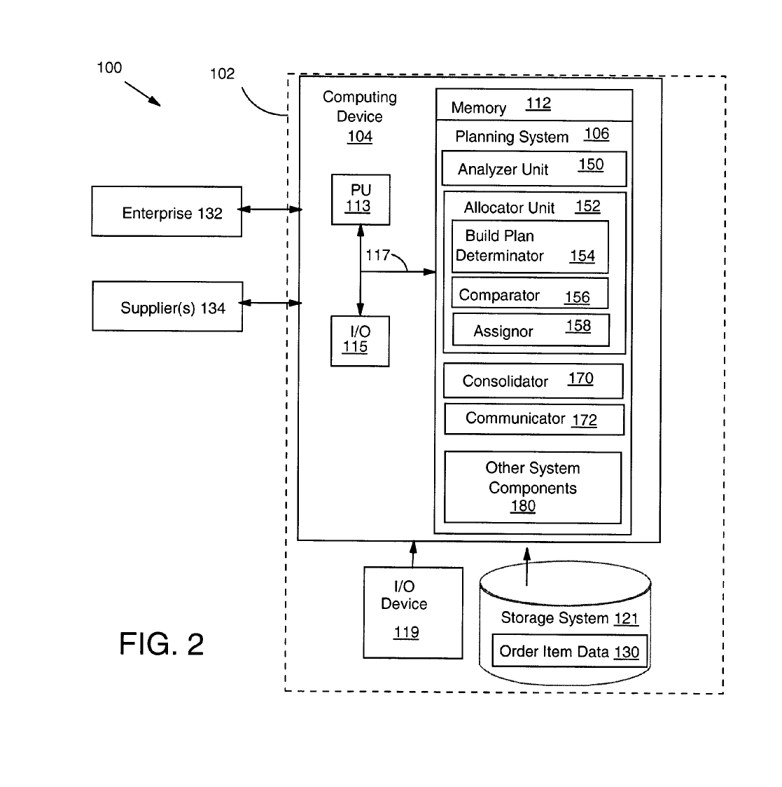

Turning to the drawings, FIG. 2 shows an illustrative environment 100 for providing supply and demand planning. To this extent, environment 100 includes a computer infrastructure 102 that can perform the various process steps described herein for providing supply and demand planning. In particular, computer infrastructure 102 is shown including a computing device 104 that comprises a planning system 106, which enables computing device 104 to provide supply and demand planning for a unit by performing the process steps of the invention.

Computing device 104 is shown including a memory 112, a processing unit (PU) 113, an input/output (I/O) interface 115, and a bus 117. Further, computing device 104 is shown in communication with an external I/O device/resource 119 and a storage system 121. As is known in the art, in general, processor 113 executes computer program code, such as planning system 106, that is stored in memory 112 and/or storage system 121. While executing computer program code, processor 113 can read and/or write, for example, order item data 130, e.g., order item details, shipment history, etc., to/from memory 112, storage system 121, and/or 1/O interface 115. Bus 117 provides a communications link between each of the components in computing device 104. I/O device 119 can comprise any device that enables a user to interact with computing device 104 or any device that enables computing device 104 to communicate with one or more other computing devices.

In any event, computing device 104 can comprise any general purpose computing article of manufacture capable of executing computer program code installed by a user (e.g., a personal computer, server, handheld device, etc.). However, it is understood that computing device 104 and planning system 106 are only representative of various possible equivalent computing devices that may perform the various process steps of the invention. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in one embodiment, computer infrastructure 102 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

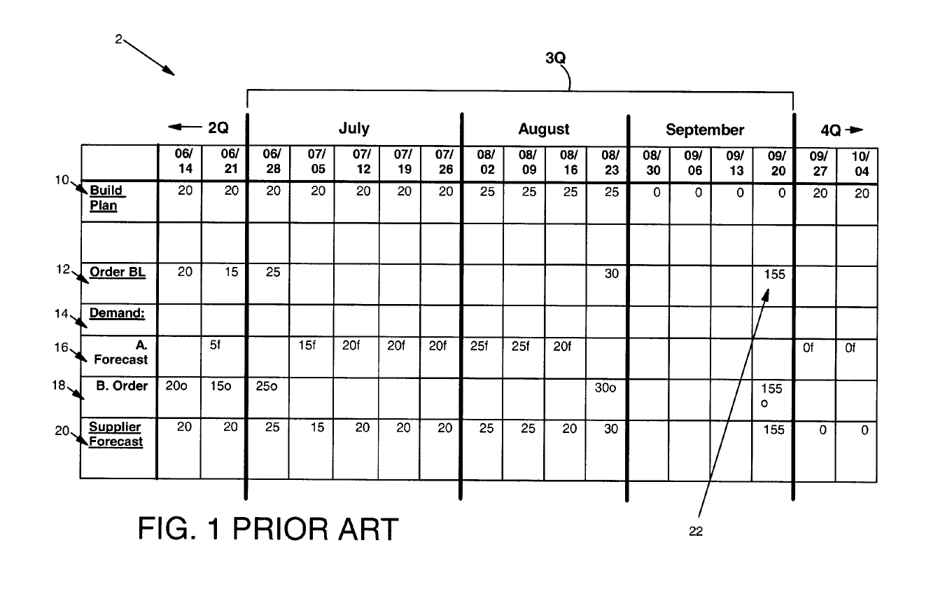

As previously mentioned and discussed further below, planning system 106 enables computing infrastructure 102 to provide supply and demand planning. To this extent, planning system 106 is shown including an analyzer unit 150; an allocator unit 152 including a build plan determinator 154, a comparator 156 and an assignor 158; a consolidator 170, a communicator 172 and other system components 180. Other system components 180 may include any other functions typically provided as part of a conventional supply and demand planning system such as ship netting, demand skewing, offsets, etc. Operation of each of these systems is discussed further below. However, it is understood that some of the various systems shown in FIG. 1 can be implemented independently, combined, and/or stored in memory for one or more separate computing devices that are included in computer infrastructure 102. Further, it is understood that some of the systems and/or functionality may not be implemented, or additional systems and/or functionality may be included as part of environment 100. Enterprise 132 and one or more suppliers 134 interact with planning system 106, e.g., via I/O interface(s) 115.

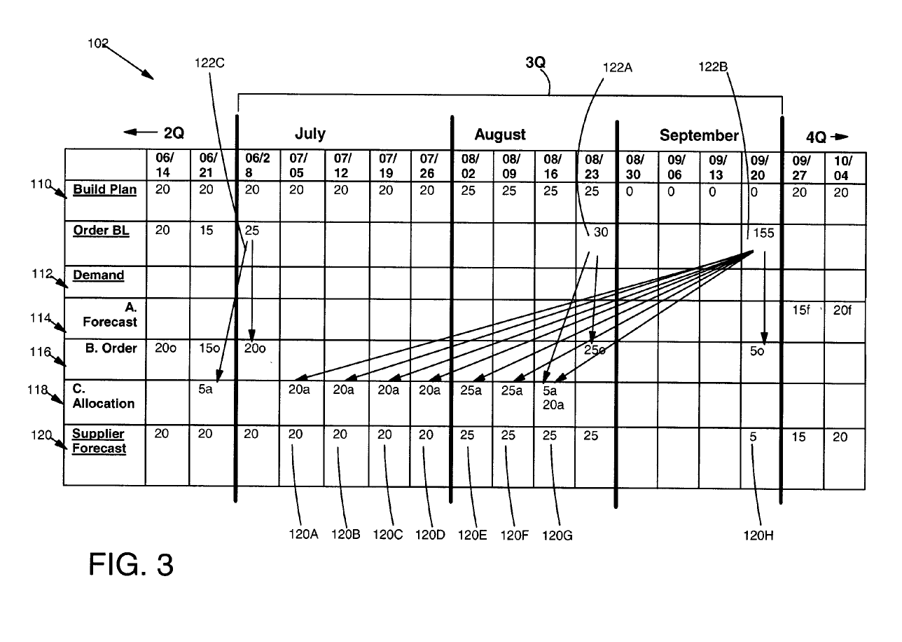

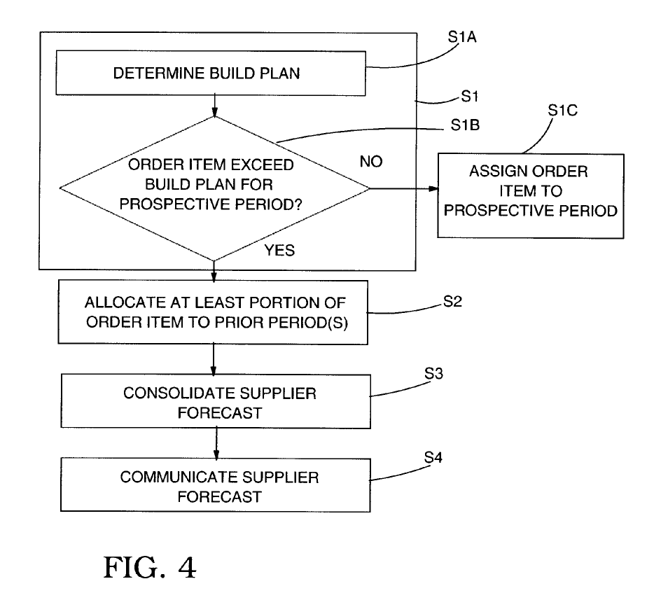

Turning to FIGS. 3-4, one embodiment of an operational methodology of the above-described planning system 106 will now be described in conjunction with FIG. 2. FIG. 3 shows a table with the same base data as that of FIG. 1, but illustrating one embodiment of a method of supply and demand planning according to the invention. FIG. 4 shows a flow diagram of one embodiment of an operational methodology of the system of FIG. 2.

For purposes of description, assume that the date is within the week of 6/21 relative to FIG. 3. Also, for purposes of description, each period of review (sometimes referred to as a bucket) is shown as a week, but the periods of review could be other durations, e.g., days, months, years, etc. The illustrative timeframe requires review in terms of five day weeks, hence, the months are slightly askew with July including 5 weeks and August and September including 4 weeks. The illustrative spreadsheet also assumes a one-for-one unit attach rate per sellable item, i.e., one sellable item requires one unit from the supplier.

In a first step S1 (FIG. 4), analyzer unit 150 analyzes order items to identify an order item occurring at a prospective period that exceeds an enterprise build plan 110 for the prospective period. For example, order items 122A, 122B, 122C for week 8/23, week 9/20 and week 6/21, respectively, exceed build plan 110 for their corresponding prospective periods. Order item 122A exceeds build plan 110 for week 8/23 by 5 units; order item 122B exceeds build plan 110 for week 9/20 by 155 units; and order item 122C exceeds build plan 110 by 5 units for week 6/28. Step S1 (FIG. 4) may include the following sub-steps: sub-step S1A (FIG. 4) in which build plan determinator 154 determines a build plan 110, e.g., by determining the objectives set for enterprise 132. In sub-step S1 B (FIG. 4), comparator 156 determines whether the order item exceeds the build plan 110 for the prospective period. This sub-step is repeated for each order item in a prospective period. If NO at sub-step S1B, i.e., the order item occurring at the prospective period does not exceed the enterprise build plan 110 for the prospective period, then at sub-step S1C, assignor 158 assigns the order item to supplier forecast 120 for the prospective period. If YES at sub-step S1B, i.e., the order item occurring at the prospective period exceeds the enterprise build plan for the prospective period, then step S2 is next.

In step S2 (FIG. 4), allocator unit 152 allocates at least a portion of the order item 122A, 122B, 122C to a supplier forecast 120 for at least one period prior to (hence, backward from) the prospective period. For example, as shown by the grouping of arrows in FIG. 3, order item 122A, which includes 30 units and exceeds build plan 110 for week 8/23 by 5 units, has the 5 units allocated to supplier forecast 120 for week 8/16 for which no aggregated demand 114 is reported. The remaining 25 units are denoted as demand order 116 for week 8/23. That is, aggregated demand 112 and, hence, supplier forecast 120, now includes demand forecast 114, demand order 116 and allocation 118. Similarly, order item 122B, which includes 155 units and exceeds build plan 110 for week 9/20 by 155 units, has the 155 units allocated to weeks 7/05 to week 8/16. As indicated, allocator unit 152 allocates portions of order item 122B to supplier forecast 120 such that supplier forecasts 120A-120G do not exceed enterprise build plan 110 for each period prior to the prospective period. That portion of an order item that does not exceed the build plan is assigned to demand order 116, e.g., as shown for order item 122C. Where the allocation of an order item, e.g., 122B, does not (or cannot) consume all of the order item in the enterprise build plan 110 for the prospective period, e.g., week 9/20, allocator unit 152 may exceed the supplier forecast 120H for the prospective period of the enterprise build plan 110 for the prospective period. Hence, supplier forecast 120H, which would normally be zero because the build plan for week 9/20 is zero, includes 5 units, which enterprise 132 (FIG. 2) challenges supplier 134 (FIG. 2) to fulfill.

In step S3 (FIG. 4), consolidator 170 (FIG. 2) consolidates supplier forecast 120 to I allocated order item 118, demand order 116 and demand forecast 114. In step S4, communicator 172 communicates supplier forecast 120 to the supplier 134. Communicator 172 may include any now known or later developed communication mechanism, e.g., e-mail, etc.

It is understood that the order of the above-described steps is only illustrative. To this extent, one or more steps can be performed in parallel, in a different order item, at a remote time, etc. Further, one or more of the steps may not be performed in various embodiments of the invention.

While shown and described herein as a method and system for providing supply and demand planning, it is understood that the invention further provides various alternative embodiments. For example, in one embodiment, the invention provides a computer-readable medium that includes computer program code to enable a computer infrastructure to provide supply and demand planning. To this extent, the computer-readable medium includes program code, such as planning system 106 (FIG. 2), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 2) and/or storage system 121 (FIG. 2) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to provide supply and demand planning as described above. In this case, the service provider can manage (e.g., create, maintain, support, etc.) a computer infrastructure, such as computer infrastructure 102 (FIG. 2), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of providing a service for providing supply and demand planning. In this case, a computer infrastructure, such as computer infrastructure 102 (FIG. 2), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 104 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for supply and demand planning in an enterprise, the method comprising the steps of:
identifying an order item occurring at a prospective period that exceeds an enterprise build plan for the prospective period; and
allocating at least a portion of the order item to a supplier forecast for at least one period prior to the prospective period.

2. The method of claim 1, wherein the allocating step includes allocating the at least a portion of the order item to the supplier forecast such that the supplier forecast does not exceed the enterprise build plan for each period prior to the prospective period.

3. The method of claim 1, further comprising the step of exceeding the supplier forecast for the prospective period of the enterprise build plan for the prospective period in the case that the allocation of the order item does not consume all of the order item in the enterprise build plan for the prospective period.

4. The method of claim 1, wherein the identifying step includes:
determining the enterprise build plan for the prospective period;
determining whether the order item exceeds the enterprise build plan for the prospective period.

5. The method of claim 1, further comprising the step of assigning the order item occurring at the prospective period that does not exceed the enterprise build plan for the prospective period to the supplier forecast for the prospective period.

6. The method of claim 1, further comprising the step of consolidating the supplier forecast including the allocated order item with a firm order demand forecast, and communicating the supplier demand forecast to the supplier.

7. A method of providing a service including supply and demand planning, the method comprising:
obtaining a computer infrastructure; and
for each of the steps of claim 1, deploying a unit for performing the step to the computer infrastructure.

8. A computer-readable medium for enabling a computer infrastructure to perform supply and demand planning, the computer-readable medium comprising computer program code for performing the method steps of claim 1.

9. A system for supply and demand planning, the system comprising:
an analyzer unit for identifying an order item occurring at a prospective period that exceeds an enterprise build plan for the prospective period; and
an allocator unit for allocating at least a portion of the order item to a supplier forecast for at least one period prior to the prospective period.

10. The system of claim 9, wherein the allocator unit allocates the at least a portion of the order item to the supplier forecast such that the supplier forecast does not exceed the enterprise build plan for each period prior to the prospective period.

11. The system of claim 9, wherein the allocator allows exceeding the supplier forecast for the prospective period of the enterprise build plan for the prospective period in the case that the allocation of the order item does not consume all of the order item in the enterprise build plan for the prospective period.

12. The system of claim 9, wherein the analyzer unit includes:
a build plan determinator for determining the enterprise build plan for the prospective period;
a comparator for determining whether the order item exceeds the enterprise build plan for the prospective period.

13. The system of claim 9, wherein the allocator includes an assigner for assigning the order item occurring at the prospective period that does not exceed the enterprise build plan for the prospective period to the supplier forecast for the prospective period.

14. The system of claim 9, further comprising a consolidator for consolidating the supplier forecast including the allocated order item with a firm order demand forecast, and a communicator for communicating the supplier demand forecast to the supplier.

15. A program product stored on a computer-readable medium, which when executed, provides supply and demand planning for a unit, the program product comprising:
program code for identifying an order item occurring at a prospective period that exceeds an enterprise build plan for the prospective period; and
program code for allocating at least a portion of the order item to a supplier forecast for at least one period prior to the prospective period.

16. The program product of claim 15, wherein the allocating code allocates the at least a portion of the order item to the supplier forecast such that the supplier forecast does not exceed the enterprise build plan for each period prior to the prospective period.

17. The program product of claim 15, wherein the allocating code allows exceeding the supplier forecast for the prospective period of the enterprise build plan for the prospective period in the case that the allocation of the order item does not consume all of the order item in the enterprise build plan for the prospective period.

18. The program product of claim 15, wherein the allocating code includes:
program code for determining the enterprise build plan for the prospective period;
program code for determining whether the order item exceeds the enterprise build plan for the prospective period.

19. The program product of claim 15, wherein the allocating codes includes program code for assigning the order item occurring at the prospective period that does not exceed the enterprise build plan for the prospective period to the supplier forecast for the prospective period.

20. The program product of claim 15, further comprising program code for consolidating the supplier forecast including the allocated order item with a firm order demand forecast, and program code for communicating the supplier demand forecast to the supplier.
